(19) United States
(12) Patent Application Publication
(10) Pub. No.: US 2023/0410047 A1
(43) Pub. Date: Dec. 21, 2023

(54) EXECUTION METHOD OF ONLINE DISCUSSION BOARD AND SERVER USING THE SAME

(71) Applicant: UNITED MICROELECTRONICS CORP., Hsinchu (TW)

(72) Inventors: Ching-Pei LIN, Hsinchu County (TW); Te-Hsuan CHEN, Tainan City (TW)

(21) Appl. No.: 17/866,595

(22) Filed: Jul. 18, 2022

(30) Foreign Application Priority Data
Jun. 15, 2022 (TW) 111122203

(51) Int. Cl. G06Q 10/10; G06Q 10/06; H04L 12/18

(52) U.S. Cl. CPC G06Q 10/103; G06Q 10/06; H04L 12/1822

(57) ABSTRACT

An execution method of an online discussion board and a server using the same are provided. The server includes an information collection unit, an analyzing unit, a discussion board management unit and a recording unit. The information collection unit is configured to obtain a plurality of process problem messages. The analyzing unit is configured to automatically obtain a process analysis report according to the process problem messages. The discussion board management unit is configured to automatically create the online discussion board. At least two users are invited to enter the online discussion board. The process analysis report is shown in the online discussion board. The recording unit is configured to store a discussion record on the online discussion board. The online discussion board is held for a period of time.

This application claims the benefit of Taiwan application Serial No. 111122203, filed Jun. 15, 2022, the disclosure of which is incorporated by reference herein in its entirety.

### TECHNICAL FIELD

The disclosure relates in general to an execution method and an electronic device using the same, and more particularly to an execution method of an online discussion board and a server using the same.

### BACKGROUND

With the advancement of semiconductor technology, various semiconductor products are invented. The rapidly changing semiconductor products cause the semiconductor production lines to face various process problems that continue to emerge, such as parameter design problems of new products, equipment problems, factory affairs questions, etc.

In the past, when encountering various process problems, a meeting must be initiated by a certain engineering department, and each department is requested to participate in the discussion to seek solutions. However, these process problems are often difficult to be solved in one or two hours of meeting. If there is no follow-up meeting, it is difficult to completely solve the process problem. Even if several meetings are held for a process problem, the timeliness is often lost.

Therefore, for complex and time-sensitive process problems, an emerging technology is needed to be developed to improve the efficiency of discussing the process problems.

### SUMMARY

The disclosure is directed to an execution method of an online discussion board and a server using the same. The relevant users can enter the online discussion board through various terminal devices for discussion to find out solutions. The users do not need to take time to participate in the meeting at the same time, the users are free to enter the online discussion board at different times, and provide comments and files. For complex and time-sensitive process problems, they can be solved on the online discussion board. The online discussion board has become the information center for specific issues, and information will no longer be scattered in various departments. The users can find the online discussion board with the same topic through the search function to seek solutions.

According to one embodiment, a server for executing an online discussion board is provided. The server includes an information collection unit, an analyzing unit, a discussion board management unit and a recording unit. The information collection unit is configured to obtain a plurality of process problem messages. The analyzing unit is configured to automatically obtain a process analysis report according to the process problem messages. The discussion board management unit is configured to automatically create the online discussion board. At least two users are invited to enter the online discussion board. The process analysis report is shown in the online discussion board. The recording unit is configured to store a discussion record on the online discussion board. The online discussion board is held for a period of time.

According to another embodiment, an execution method of an online discussion board is provided. The execution method of the online discussion board includes the following steps. A plurality of process problem messages are obtained. A process analysis report is automatically obtained according to the process problem messages. The online discussion board is automatically created. At least two users are invited to enter the online discussion board. The process analysis report is shown in the online discussion board. A discussion record is stored on the online discussion board. The online discussion board is held for a period of time.

### BRIEF DESCRIPTION OF THE DRAWINGS

FIG. 1 shows a collection of process problems according to an embodiment.

FIG. 2 shows a block diagram of the server according to an embodiment.

FIG. 3 shows a flow chart of the execution method of the online discussion board according to an embodiment.

FIG. 4 illustrates an example of the online discussion board.

FIG. 5 shows a flowchart of a search method for the online discussion board according to an embodiment.

FIG. 6 illustrates a searching page according to an embodiment.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

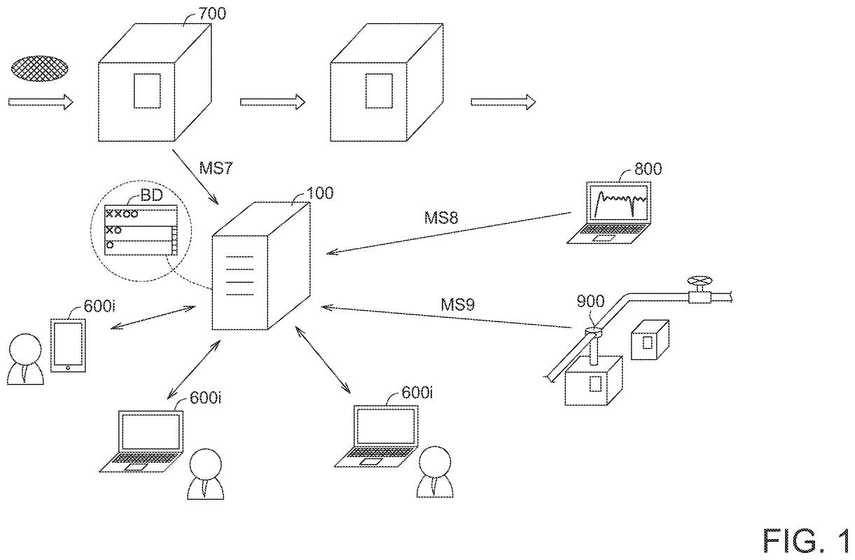

Please refer to FIG. 1, which shows a collection of process problems according to an embodiment. Under the trend of rapid changes in semiconductor products, semiconductor factories are faced with various new challenges. These process problems are, for example, the equipment/product problems detected by a process apparatus 700, the parameter design problems faced by the R&D personnel when an electronic device 800 is designing new products, or the factory affairs problems faced by a process supply system 900.

A server 100 of the present disclosure can collect a plurality of process problem messages MS7, MS8, MS9 from the process apparatus 700, the electronic device 800 or the process supply system 900, and initiate an online discussion board BD (shown in FIG. 1) according to process problem message MS7, MS8, MS9. Relevant users can enter the online discussion board BD through various terminal devices 600i for discussion to find out solutions.

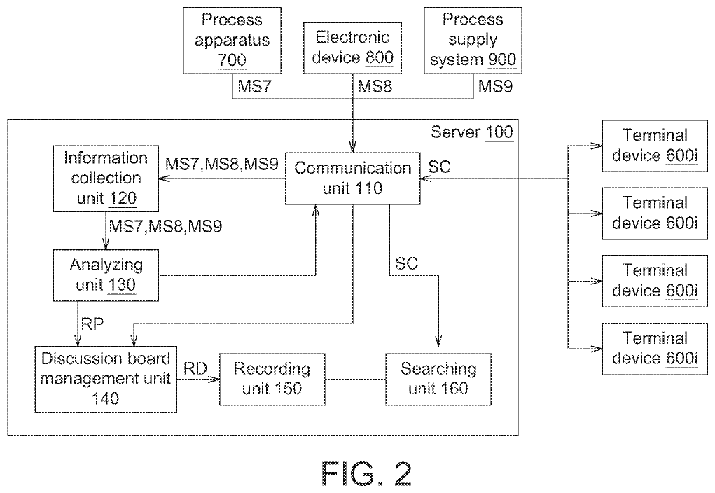

Please refer to FIG. 2, which shows a block diagram of the server 100 according to an embodiment. The server 100 includes a communication unit 110, an information collection unit 120, an analyzing unit 130, a discussion board management unit 140, a recording unit 150 and a searching unit 160. The functions of each component are outlined below. The communication unit 110 is used to transmit various information, such as a wired network transmission module, a wireless network transmission module, a Bluetooth communication module, or an LTE communication module. The information collection unit 120 is used to collect various information. The analyzing unit 130 is used to execute analysis programs. The discussion board management unit 140 is used to manage the online discussion board BD. The recording unit 150 is used for recording information. The searching unit 160 is used for searching for information. The information collection unit 120, the analyzing unit 130, the discussion board management unit 140, the recording unit 150 and the searching unit 160 are, for example, a circuit, a chip, a circuit board, a code, a computer program product, or a storage device for storing the code.

In the present embodiment, after the information collection unit 120 collects the various process problem messages MS7, MS8, and MS9, the discussion board management unit 140 can initiate the online discussion board BD (shown in FIG. 1), so that the relevant users can enter the online discussion board BD through various terminal devices 600i for discussion to discuss solutions. The establishment and management of the online discussion board BD in this embodiment is not performed manually, but must rely on the sensors on the process. After the apparatuses or the devices obtain the process problem messages MS7, MS8, and MS9, the server 100 automatically creates the online discussion board BD. The execution of the online discussion board BD must be achieved by the information processing technology, not mental process. The following is a detailed description of the operation of each component with a flow chart.

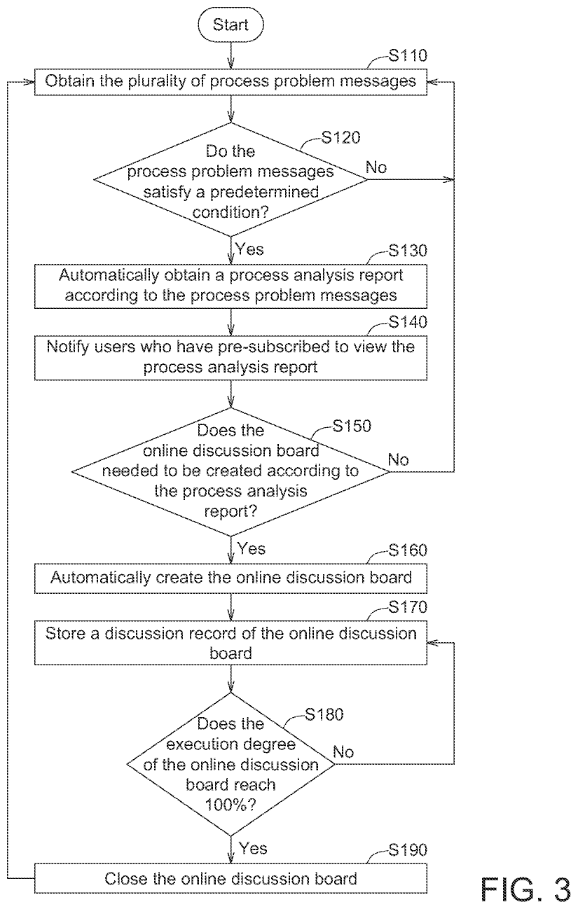

Please refer to FIG. 3, which shows a flow chart of the execution method of the online discussion board BD according to an embodiment. In step S110, the information collection unit 120 obtains the plurality of process problem messages MS7, MS8, MS9. For example, the information collection unit 120 periodically asks the process apparatus 700, the electronic device 800 or the process supply system 900 for the process problem messages MS7, MS8, MS9. Alternatively, the process apparatus 700, the electronic device 800 or the process supply system 900 actively transmits the process problem messages MS7, MS8, MS9 to the information collection unit 120. The information collection unit 120 is classified according to some predetermined classification rules and provided to the analyzing unit 130.

Then, in step S120, the analyzing unit 130 determines whether the process problem messages MS7, MS8, MS9 satisfy a predetermined condition. For example, the predetermined condition is that the number of the same process problem message reaches a predetermined number, the deviation value described in the process problem message is higher than a predetermined level, or the process problem message belongs to a specific serious matter. If the process problem messages MS7, MS8, MS9 satisfy the predetermined condition, the process proceeds step S130; if the process problem messages MS7, MS8, MS9 do not satisfy the predetermined condition, the process go1 back to the step S110.

Then, in step S130, the analyzing unit 130 automatically obtains a process analysis report RP according to the process problem messages MS7, MS8, and MS9. The analyzing unit 130 can automatically perform appropriate statistical analysis and related data collection according to the characteristics of the process problem messages MS7, MS8, MS9. The process analysis report RP includes one statistical data of the process problem messages MS7, MS8, MS9, at least one abnormal process procedure, at least one parameter setting data and at least one time data. For example, when the process problem message MS7 points out that a product fails the WAT test, the analyzing unit 130 can count the failure rate, and summarize the equipment information and parameter setting information. Alternatively, when the process problem message MS9 indicates that a certain gas flow rate is insufficient, the analyzing unit 130 can draw a time sequence change diagram of the gas flow rate, and integrate the values of all the detectors on the pipeline.

Next, in step S140, the analyzing unit 130 notifies users who have pre-subscribed to view the process analysis report RP through the communication unit 110. Each user has its own specific rights when registering the online discussion board BD. The users can subscribe to related issues according to their permissions. The process analysis report RP can notify the users having pre-subscribed by email, push message, or SMS. For example, the photolithography process engineers can subscribe to some topics related to the photolithography equipment according to their permissions. Factory engineers can subscribe to some issues related to the factory affairs according to their permissions. The process analysis report RP may be stored only in the server 100 and not transmitted directly to the user. The user needs to connect to the server 100 to view the process analysis report RP, so as to avoid the process analysis report RP from flowing out of the factory. In the case that the process analysis report RP does not flow out, the notified terminal device 600i can no longer be limited to the computer in the factory, but can be a personal mobile phone or laptop.

Then, in step S150, the discussion board management unit 140 determines whether to create the online discussion board BD according to the process analysis report RP. The discussion board management unit 140 can automatically create the online discussion board BD according to a determination condition. For example, if the issues involved in the process analysis report RP are related to the created online discussion board BD, no new online discussion board BD will be created; if the issues involved in the process analysis report RP are not related to all created online discussion board BDs discussion board BD, a new online discussion board BD will be created automatically. When the discussion board management unit 140 decides not to create a new online discussion board BD, the discussion board management unit 140 may provide the process analysis report RP to the existing online discussion board BD.

Alternatively, the discussion board management unit 140 may passively wait for a subscribed user to request. For example, within a predetermined time (for example, two days), if the discussion board management unit 140 receives a creation request from a subscribed user, the discussion board management unit 140 automatically creates the online discussion board BD; if no establishment request is received from the subscribed user, the discussion board management unit 140 does not establish the online discussion board BD.

If it is determined that the online discussion board BD is to be created, then the process proceeds to step S160; if it is determined not to create the online discussion board BD, then the process goes back to the step S110.

In the step S160, the discussion board management unit 140 automatically creates the online discussion board BD. In this step, at least two users are invited to enter to the online discussion board BD, and the process analysis report RP is shown on the online discussion board BD. The discussion board management unit 140 can automatically invite the subscribed users to the online discussion board BD. Alternatively, the initiator can click on this online discussion board BD to invite a specific user to enter to this online discussion board BD.

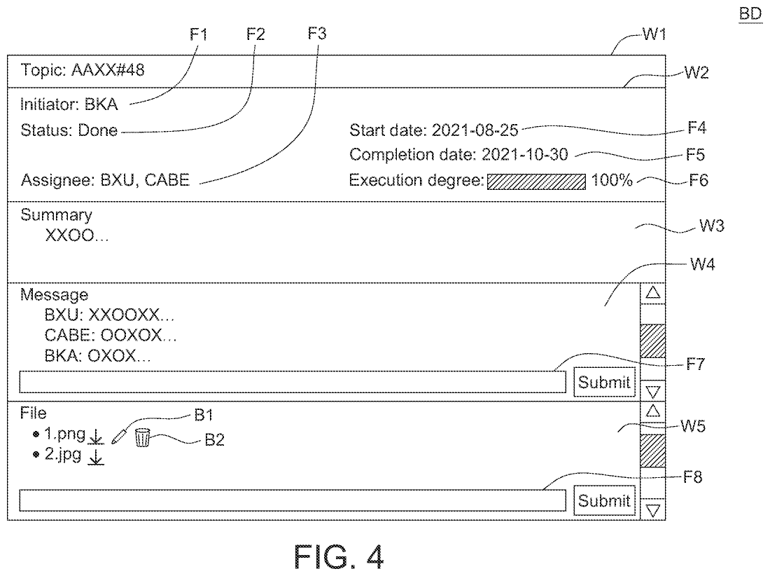

The invited users can freely enter this online discussion board BD at different times, and consult information and express opinions on the online discussion board BD. Please refer to FIG. 4, which illustrates an example of the online discussion board BD. A title window W1 of the online discussion board BD displays the topic being discussed. An information window W2 of the online discussion board BD displays various basic information. An initiator field F1 of the information window W2 is used to display the initiator. A status field F2 of the information window W2 is used to display the current status. An assignee field F3 of the information window W2 is used to display the invited users. An initiating date field F4 of the information window W2 is used to display the time of initiation. A completion date field F5 of the information window W2 is used to display the estimated completion time. The estimated completion time can be set and adjusted by the initiator. An execution degree field F6 of the information window W2 is used to display the execution degree. The execution degree can be edited by the initiator.

A summary window W3 of the online discussion board BD is used to describe the summary content of the topic. A message discussion window W4 of the online discussion board BD is used for the users to express their opinions. The users can enter text messages in the message inputting field F7. A file information window W5 of the online discussion board BD is used to list related files. The users can upload files in the file list field F8. The user who provided the file can edit it by an editing button B1 and delete it by a deleting button B2.

Then, in step S170, the recording unit 150 stores a discussion record RD of the online discussion board BD. The online discussion board BD will last for a period of time (such as days or months), and all messages and files during this period will be stored in the discussion record RD. That is to say, the online discussion board BD becomes the information center for this specific issues, and the information will no longer be scattered in various departments.

Then, in step S180, the discussion board management unit 140 determines whether the execution degree of the online discussion board BD reaches 100%. If the execution degree reaches 100%, the process proceeds to step S190.

In the step S190, the discussion board management unit 140 closes the online discussion board BD. The so-called “close” means to stop letting users post messages, and stop letting users provide files. But the content of the online discussion board BD still remains in the server 100 for users to consult. When the related process problem message MS7, MS8, MS9 occurs in the future, and the same topic needs to be continued for discussion, the online discussion board BD can be opened again by the discussion board management unit 140.

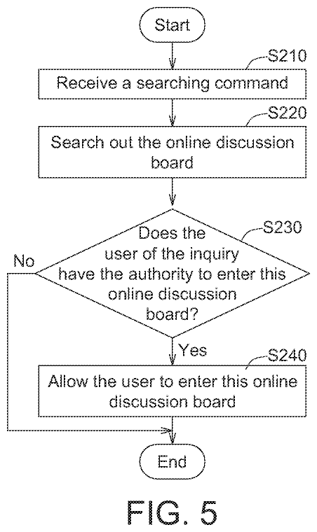

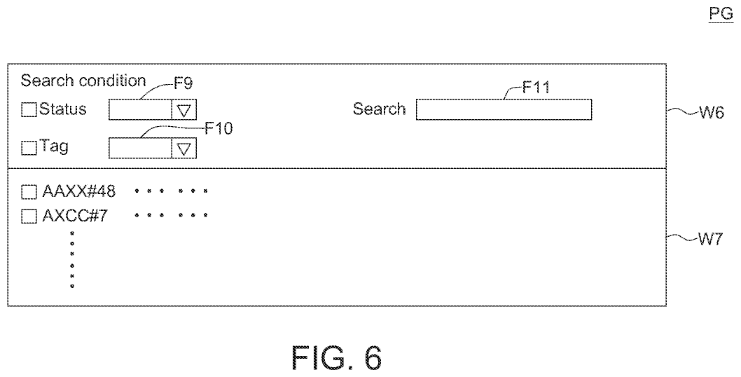

In addition, the online discussion board BD is also available for the users to search. Please refer to FIG. 5, which shows a flowchart of a search method for the online discussion board BD according to an embodiment. In step S210, the searching unit 160 receives a searching command SC. Please refer to FIG. 6, which illustrates a searching page PG according to an embodiment. The users can select the status in a status field F9 of a conditional inputting window W6, and select the label in a tab field F10 of a conditional inputting window W6. The user can also enter the string to be searched in a string inputting field F11 of the conditional inputting window W6. According to these input contents, the searching command SC can be formed.

Then, in step S220, the searching unit 160 searches out the online discussion board BD, which is qualified, according to the searching command SC. Some online discussion board BDs, which are eligible, will be listed in a search result window W7.

Then, in step S230, the discussion board management unit 140 checks whether the user of the inquiry has the authority to enter this online discussion board BD. If the user has the right to enter the online discussion board BD, the process proceeds to step S230; if the user does not have the right to enter the online discussion board BD, then process is terminated.

Then, in step S240, the discussion board management unit 140 allows the user to enter this online discussion board BD. This user can get solutions to the related issues on this online discussion board BD.

According to the above-mentioned embodiments, the relevant users can enter the online discussion board BD through various terminal devices 600i for discussion to find out solutions. The users do not need to take time to participate in the meeting at the same time, the users are free to enter the online discussion board BD at different times, and provide comments and files. For complex and time-sensitive process problems, they can be solved on the online discussion board BD. The online discussion board BD has become the information center for specific issues, and information will no longer be scattered in various departments. The users can find the online discussion board BD with the same topic through the search function to seek solutions.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A server for executing an online discussion board, comprising:
an information collection unit, configured to obtain a plurality of process problem messages;
an analyzing unit, configured to automatically obtain a process analysis report according to the process problem messages;
a discussion board management unit, configured to automatically create the online discussion board, wherein at least two users are invited to enter the online discussion board, and the process analysis report is shown in the online discussion board; and
a recording unit, configured to store a discussion record on the online discussion board, wherein the online discussion board is held for a period of time.

2. The server according to claim 1, wherein the analyzing unit determines whether the process problem messages meet a predetermined condition, and when the process problem messages meet the predetermined condition, the analyzing unit automatically obtains the process analysis report.

3. The server according to claim 1, wherein the process analysis report includes a statistical data, at least one process abnormal procedure, at least one parameter setting data and at least one time data of the process problem messages.

4. The server according to claim 1, further comprising:
a communication unit, configured to inform a user who has pre-subscribed to view the process analysis report.

5. The server according to claim 1, wherein the discussion board management unit holds the online discussion board for a plurality of days.

6. The server according to claim 1, wherein the discussion board management unit allows the users to enter the online discussion board at different times.

7. The server according to claim 1, wherein if an execution degree has reached 100%, the discussion board management unit closes the online discussion board.

8. The server according to claim 1, wherein the discussion board management unit receives a plurality of text messages and at least one file from the users, and displays the text messages and the at least one file on the online discussion board.

9. The server according to claim 8, wherein the discussion board management unit lists the at least one file in a file information window of the online discussion board.

10. The server according to claim 1, the discussion board management unit searches the online discussion board via a Natural Language Processing (NLP) algorithm.

11. An execution method of an online discussion board, comprising:
obtaining a plurality of process problem messages;
automatically obtaining a process analysis report according to the process problem messages;
automatically creating the online discussion board, wherein at least two users are invited to enter the online discussion board, and the process analysis report is shown in the online discussion board; and
storing a discussion record on the online discussion board, wherein the online discussion board is held for a period of time.

12. The execution method of the online discussion board according to claim 11, wherein when the process problem messages meet a predetermined condition, the step of automatically obtaining the process analysis report is performed.

13. The execution method of the online discussion board according to claim 11, wherein the process analysis report includes a statistical data, at least one process abnormal procedure, at least one parameter setting data and at least one time data of the process problem messages.

14. The execution method of the online discussion board according to claim 11, further comprising:
informing a user who has pre-subscribed to view the process analysis report.

15. The execution method of the online discussion board according to claim 11, wherein the online discussion board is held for a plurality of days.

16. The execution method of the online discussion board according to claim 11, wherein the users enter the online discussion board at different times.

17. The execution method of the online discussion board according to claim 11, further comprising:
closing the online discussion board, if an execution degree has reached 100%.

18. The execution method of the online discussion board according to claim 11, wherein a plurality of text messages and at least one file transmitted from the users are displayed on the online discussion board.

19. The execution method of the online discussion board according to claim 18, wherein the at least one file is listed in a file information window of the online discussion board.

20. The execution method of the online discussion board according to claim 11, further comprising:
searching the online discussion board via a Natural Language Processing (NLP) algorithm.
